(19) United States
(12) Patent Application Publication
(10) Pub. No.: US 2025/0198792 A1
(43) Pub. Date: Jun. 19, 2025

(54) METHOD FOR MAPPING AT LEAST ONE LOCATION ON A ROAD SUITABLE FOR OVERTAKING

(71) Applicant: Robert Bosch GmbH, Stuttgart (DE)

(72) Inventors: Lewis Luyken, Cockatoo Vic (AU); Max Henty-Scown, Clayton (AU)

(21) Appl. No.: 18/951,733

(22) Filed: Nov. 19, 2024

(30) Foreign Application Priority Data
Dec. 18, 2023 (DE) 10 2023 212 860.8

(51) Int. Cl. G01C 21/00

(52) U.S. Cl. CPC G01C 21/3819

(57) ABSTRACT

A method for mapping at least one location on a road suitable for overtaking. The method including: ascertaining a plurality of factors of the road relevant to overtaking; ascertaining a suitability measure for at least one location on the road which indicates a measure of suitability for overtaking at that location based on the ascertained factors relevant to overtaking; entering the ascertained suitability measure into a digital road map representing the road. A device, a computer program, and a machine-readable storage medium are also described.

### CROSS REFERENCE

The present application claims the benefit under 35 U.S.C. § 119 of German Patent Application No. DE 10 2023 212 860.8 filed on Dec. 18, 2023, which is expressly incorporated herein by reference in its entirety.

### FIELD

The present invention relates to a method for mapping at least one location on a road suitable for overtaking, a device, a computer program, and a machine-readable storage medium.

### BACKGROUND INFORMATION

U.S. Patent Application Publication No. US 2022/0324467 A1 describes a safety system for a vehicle.

Japan Patent Application No. JP 2022110001 A describes a method for autonomous vehicle navigation.

Germany Patent Application No. DE 10 2022 001 253 A1 describes a method for mapping hazardous stretches of road.

Japan Patent Application No. JP 2006293615 A describes a device that provides information to assist a driver of a vehicle when overtaking. The information required for this is taken from a database. How this information is ascertained, however, it is not specifically discussed.

### SUMMARY

An object of the present invention is to provide mapping at least one location on a road suitable for overtaking.

This object may be achieved using certain features of the present invention. Advantageous example embodiments of the present invention are disclosed herein.

According to a first aspect of the present invention, a method for mapping at least one location on a road suitable for overtaking is provided. According to an example embodiment of the present invention, the method comprises the following steps:
ascertaining a plurality of factors of the road relevant to overtaking,
ascertaining a suitability measure for at least one location on the road which indicates a measure of suitability for overtaking at that location based on the ascertained factors relevant to overtaking,
entering the ascertained suitability measure into a digital road map representing the road.

According to a second aspect of the present invention, a device is provided, which is configured to carry out all steps of the method according to the first aspect of the present invention.

According to a third aspect of the present invention, a computer program is provided, which comprises instructions that, when the computer program is executed by a computer, for example by the device according to the second aspect of the present invention, cause said computer to carry out a method according to the first aspect.

According to a fourth aspect of the present invention, a machine-readable storage medium is provided, on which the computer program according to the third aspect of the present invention is stored.

The present invention is based on and includes the realization that a plurality of factors of the road relevant to overtaking are ascertained, based on which a suitability measure for at least one location on the road is ascertained. This suitability measure indicates a suitability for overtaking at that location. In other words, for the one location, it indicates how suitable that location is for overtaking. This information, i.e. the ascertained suitability measure, is entered in a digital road map which represents the road.

This results in a digital road map which contains information that indicates how suitable the one location on the road is for overtaking. Based on such information, it is, for example, possible for a motor vehicle to drive on the road at least in an at least partially automated manner. A driver assistance system, for instance, can use this information to, for example, provide a driver an indication of when he/she should overtake or that he/she should not overtake.

Overtaking within the meaning of the description refers to a road user being overtaken by a motor vehicle, whereby both the road user and the motor vehicle are moving or driving on the road.

The phrase “at least one” means “one or more”. This means that when the singular is used for the location, the plural is also always meant and vice versa. This means in particular that the method provides for a suitability measure to be ascertained for a plurality of locations on the road, for example, and the ascertained suitability measures are entered into the digital road map.

Entering the ascertained suitability measure into the digital road map includes, for instance, entering the ascertained suitability measure into a separate layer of the digital road map. In other words, the digital road map comprises multiple layers, for example, and the ascertained suitability measure or the ascertained suitability measures are entered into one of the layers. The digital road map therefore comprises a layer, for example, which contains only the ascertained suitability measures.

In one example embodiment of the method of the present invention it is provided that the plurality of factors relevant to overtaking include a lane factor, wherein a number of lanes of the road in each direction of travel at the one location is ascertained, wherein the lane factor is ascertained based on the ascertained number of lanes of the road in each direction of travel.

This, for example, produces the technical advantage that a particularly suitable and meaningful factor relevant to overtaking is ascertained so that the suitability measure can be determined in a meaningful way.

In one example embodiment of the method of the present invention it is provided that the plurality of factors relevant to overtaking include a visual range factor, wherein a visual range, in particular a horizontal visual range or a vertical visual range, at the one location is ascertained, wherein the visual range factor is ascertained based on the ascertained visual range.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a curvature factor, wherein a curvature, in particular a horizontal or a vertical curvature, of the road at the one location is ascertained, wherein the curvature factor is ascertained based on the ascertained curvature.

This, for example, produces the technical advantage that a particularly suitable and meaningful factor relevant to overtaking is ascertained so that the suitability measure can be determined in a meaningful way.

In one example embodiment of the method of the present invention it is provided that the plurality of factors relevant to overtaking include a speed limit factor, wherein a maximum permissible speed at the one location is ascertained, wherein the speed limit factor is ascertained based on the ascertained maximum permissible speed.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a distance factor, wherein a distance of the road from the one location to a next junction of the road is ascertained, wherein the distance factor is ascertained based on the ascertained distance.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a road width factor, wherein a road width at the one location is ascertained, wherein the road width factor is ascertained based on the ascertained road width.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a coefficient of sliding friction factor, wherein a coefficient of sliding friction of a lane of the road at the one location is ascertained, wherein the coefficient of sliding friction is ascertained based on the ascertained coefficient of sliding friction.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a road traffic hazard factor, wherein a distance of the road from the one location to a road traffic hazard location of a road traffic hazard affecting the road is ascertained, wherein the road traffic hazard factor is ascertained based on the ascertained distance.

This, for example, produces the technical advantage that a particularly suitable and meaningful factor relevant to overtaking is ascertained so that the suitability measure can be determined in a meaningful way.

In one example embodiment of the method of the present invention, it is provided that the plurality of factors relevant to overtaking include a traffic rules relating to overtaking factor, wherein traffic rules relating to overtaking that apply at the one location are ascertained, wherein the traffic rules relating to overtaking factor is ascertained based on the traffic rules relating to overtaking that apply.

This, for example, produces the technical advantage that it is possible to efficiently ascertain whether or not overtaking is even permitted at the one location. For instance, it could be that the traffic rules stipulate that overtaking is prohibited at that one location. In such a case, the intent is for the suitability measure to indicate that that one location is not suitable for overtaking, for example, or that overtaking is prohibited here or at this one location. In this example, for instance, the traffic rules relating to overtaking factor is zero.

In one example embodiment of the method of the present invention, it is provided that the factors relevant to overtaking are scaled to a predetermined scaling interval to ascertain scaled factors relevant to overtaking, wherein the suitability measure for the one location is ascertained based on the scaled factors relevant to overtaking.

This, for example, produces the technical advantage that the suitability measure can be efficiently ascertained.

The predetermined scaling interval is 0 to 1, for example, and 0 and 1 are included in the interval. In such a case, a suitability measure of 0 means that that one location is not suitable. A suitability measure of 1 means that the one location is suitable. Values between 0 and 1 for the suitability measure thus characterize intermediate stages between unsuitable and suitable.

In one example embodiment of the method of the present invention, it is provided that the factors relevant to overtaking are at least partly weighted with an individual weighting factor to ascertain appropriately weighted factors relevant to overtaking, wherein the suitability measure for the one location is ascertained based on the weighted factors relevant to overtaking.

Providing individual weighting factors advantageously makes it possible to assign particular significance to one or more factors or, conversely, ascribe them only minor relevance.

For example, it is provided that the scaled factors relevant to overtaking are at least partly weighted with an individual weighting factor to ascertain appropriately weighted scaled factors relevant to overtaking, wherein the suitability measure for the one location is ascertained based on the weighted scaled factors relevant to overtaking.

For example, it is provided that the weighted factors relevant to overtaking are scaled to a predetermined scaling interval, for example [0, 1], in order to transmit scaled weighted factors relevant to overtaking, wherein the suitability measure for the one location is ascertained based on the scaled weighted factors relevant to overtaking.

In one example embodiment of the method of the present invention, it is provided that a respective suitability measure is ascertained for a plurality of locations on the road that are entered into the digital road map, wherein a compensation calculation is carried out based on the respectively ascertained suitability measures to ascertain a continuous function that best approximates the suitability measures respectively ascertained for the plurality of locations, wherein the ascertained function is entered into the digital road map.

This, for example, produces the technical advantage that, based on the continuous function, an individual suitability measure can be ascertained even for those locations on the road for which a respective suitability measure has not been explicitly ascertained.

In one example embodiment of the method of the present invention, it is provided that real-time surroundings data describing the current surroundings at the one location are received, wherein the suitability measure is ascertained based on the real-time surroundings data.

This, for example, produces the technical advantage that the suitability measure can be ascertained based on current information, the real-time surroundings data.

Real-time surroundings data, for instance, include one or more of the following data: weather data, surroundings sensor data of a surroundings sensor that has acquired the surroundings at the one location. Such a surroundings sensor can be the surroundings sensor of a motor vehicle traveling on the road in the direction of the one location, for example.

Real-time surroundings data include traffic data that describe the traffic at the one location, for instance.

Device features result analogously from corresponding method features and vice versa. This means in particular that technical functionalities of the device result analogously from corresponding technical functionalities of the method and vice versa.

The method is a computer-implemented method, for example.

The device of the present invention is configured in terms of programming to execute the computer program, for example.

It has been stated above that the factors relevant to overtaking are at least partly weighted with an individual weighting factor. This means, for instance, that all factors relevant to overtaking, or only some of the factors relevant to overtaking, or only one of the factors relevant to overtaking are weighted with an individual weighting factor.

The present invention is explained in more detail in the following with reference to preferred embodiment examples.

### DETAILED DESCRIPTION OF EXAMPLE EMBODIMENTS

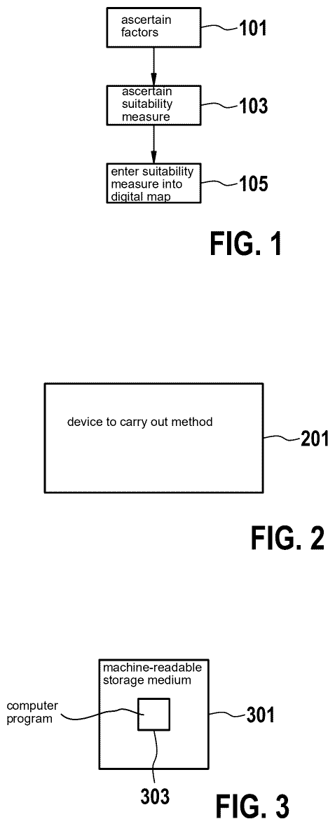

FIG. 1 shows a flowchart of a method according to the first aspect of the present invention.

FIG. 2 shows a device according to the second aspect of the present invention.

FIG. 3 shows a machine-readable storage medium, according to an example embodiment of the present invention.

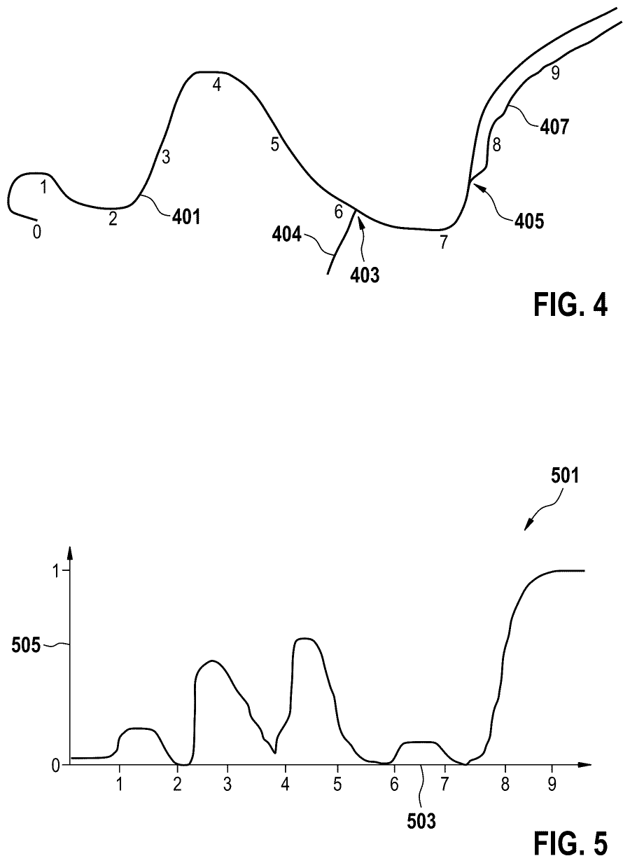

FIG. 4 shows a road.

FIG. 5 shows a course of a suitability measure along the road 401 of FIG. 4, according to an example embodiment of the present invention.

### DETAILED DESCRIPTION OF EXAMPLE EMBODIMENTS

FIG. 1 shows a flowchart of a method for mapping at least one location on a road suitable for overtaking, comprising the following steps:
ascertaining 101 a plurality of factors of the road relevant to overtaking,
ascertaining 103 a suitability measure for at least one location on the road which indicates a measure of suitability for overtaking at that location based on the ascertained factors relevant to overtaking,
entering 105 the ascertained suitability measure into a digital road map representing the road.

FIG. 2 shows a device 201, which is configured to carry out all steps of the method according to the first aspect.

FIG. 3 shows a machine-readable storage medium 301, on which a computer program 303 is stored. The computer program 303 comprises instructions that, when the computer program 303 is executed by a computer, cause the computer to carry out a method according to the first aspect.

The following abbreviations are introduced as part of the description:
f_{suitability measure} refers to the suitability measure which indicates a measure of suitability for overtaking at a location on a road.
fₗₐₙₑ refers to the lane factor.
f_{visual range} refers to the visual range factor.
f_{curvature} refers to the curvature factor.
f_{speed limit} refers to the speed limit factor.
f_{distance} refers to the distance factor.
f_{road width} refers to the road width factor of the road.
f_{coefficient of sliding friction} refers to the coefficient of sliding friction factor.
f_{road traffic hazard} refers to the road traffic hazard factor.
f_{traffic rules} refers to the traffic rules relating to overtaking factor.

The suitability of a location on a road for overtaking depends on many different factors acting simultaneously. The following equation provides an example of how these factors can be combined to calculate the suitability of a specific location for overtaking. All of the factors can be scaled from 0 to 1, for example, so that if a factor with a factor of zero indicates that overtaking at the one location is completely inappropriate, it can override all other factors. It is, for instance, also possible to set different scaling factors for each individual factor to increase or decrease its relative importance.

$${f}_{suitability measure} = {f}_{lane} \times {f}_{visual range} \times {f}_{curvature} \times {f}_{speed limit} \times {f}_{distance} \times {f}_{road width} \times {f}_{coefficient of sliding friction} \times {f}_{road traffic hazard} \times {f}_{traffic rules}$$

Lanes: The more lanes there are on a road, the more suitable a location is for overtaking; in particular if the lanes are provided for traffic traveling in the same direction. It is possible to carry out an overtaking maneuver in the opposite lane, but overtaking in lanes with the same direction of travel is better.

fₗₐₙₑ∝A_{(number of lanes, the travel direction of which is in the overtaking direction)}+B_{(number of lanes, the travel direction of which is opposite to the overtaking direction)}

The factor relating to the lanes is proportional to the number (A) of lanes pointing in an overtaking direction and the number (B) of lanes pointing in a direction opposite to the overtaking direction, for instance, in which case A is weighted higher than B, for example.

Visibility: Visual range is the key to assessing the suitability of a location for overtaking, in particular on country roads where the maneuver can be carried out in an oncoming lane. The visual range is taken account in both horizontal and vertical directions, for example. When the motor vehicle is traveling downhill, it has a greater visual range than when it is traveling toward the top of a hill. The horizontal view can be impeded by road corners, for instance. If properly accurate map data is available, however, this factor can be further modified to take into account the effects of surrounding objects, e.g. a wall or trees can impede the view around a moderately difficult corner.

f_{visual range}∝visual range

The greater the visual range, the higher the visibility factor, for example.

Road curvature: The curvature of a road has a major impact on the suitability of a location for overtaking. Overtaking maneuvers are often carried out at higher speeds and the greater the curvature of the road at a location, the more unstable the motor vehicle is when it carries out such a maneuver at that location. As is the case for the visibility, this applies to both horizontal and vertical curvatures of the road. An increasing suppression factor, which depends on the proximity to the curvature and the degree of curvature, is applied to the function for the road curvatures.

$${f}_{curvature} ∝ \frac{1}{horizontal curvature of the road at the one location} + \frac{1}{vertical curvature of the road at the one location}$$

The curvature factor is inversely proportional to the horizontal and vertical curvature, for instance.

Speed limit: Lower speed limits generally indicate a higher risk to more vulnerable road users, such as pedestrians and bicyclists who are using the road, and thus also indicate a greater risk of unexpected hazards when carrying out an overtaking maneuver.

f_{speed limit}∝maximum permissible speed at the one location

Low speeds consequently correspond to a low overtake ability factor, for example.

Distance to intersection (junction in general): For numerous reasons, intersections, junctions in general, can pose a risk on apparently suitable stretches of road. A motor vehicle could be slowing down to turn across the opposite lane, or a motor vehicle could be crossing the direction of traffic from an intersection lane.

f_{distance}∝distance of the road from the one location to a next junction of the road

The smaller the distance to an intersection, junction in general, the less suitable the location is for overtaking.

A junction in within the meaning of the description is an intersection, in particular a T-junction, or merging traffic or a highway interchange, for example.

Road width: Wider roads allow safer overtaking, because less caution is required when overtaking and therefore the maneuver can be carried out more quickly.

f_{road width}∝road width

The wider the road, the more suitable a location is for overtaking.

Road surface: Better road surfaces likewise allow safer overtaking, because they allow better handling. This can primarily be attributed to the different coefficients of sliding friction between motor vehicle tires and different road surfaces. A new asphalt surface can provide good grip, whereas unpaved dirt roads have a very low coefficient of sliding friction.

f_{coefficient of sliding friction}∝coefficient of sliding friction

The higher the coefficient of sliding friction, the more suitable a location is for overtaking.

Road traffic hazards: Real-time road hazards (generally real-time surroundings data), for example, can be included in the overtaking feasibility. The motor vehicle is wirelessly connected to a live data source, for instance, which can provide information about the location of road hazards, such as oil spills, floods, construction sites or traffic jams. Mapped non-real-time hazards such as crossing animals, stop signs and crosswalks, for instance, can be used.

f_{road traffic hazard}∝distance of the road from the one location to a road traffic hazard location of a road traffic hazard affecting the road

This factor depends in particular on the proximity of the one location to the location of the road traffic hazard. The smaller the respective distance, the less suitable the location is for overtaking. Different road traffic hazards can affect the road traffic hazard factor to varying degrees. Old data about an oil spill can have less of an effect than a crosswalk, for instance.

Traffic rules: The road traffic rules, too, can affect the suitability of a location for overtaking. The proximity to double lines on many roads, for example, means that overtaking is prohibited.

These are examples of a number of factors that can be combined with one another. The factor for the suitability for overtaking can be calculated at regular intervals along all roads and can, for example, be provided as a map layer which can be integrated into motor vehicle safety systems and used as one of the required inputs to activate autonomous overtaking maneuvers or, preferably, to provide information to an active driver about the suitability of the current location for overtaking and possibly recommend safer locations further down the road.

This thus in particular creates a concept that can be used offline to calculate the suitability of a location for overtaking that can be stored in a motor vehicle in conjunction with other standard definition map data. The data can be made available to the driver in a manner that enables safer overtaking decisions.

The suitability measure can correspond to the lowest factor of the factors, for instance. Different calculation rules can be provided for multi-lane roads and for single-lane roads, for example.

A motor vehicle connected to real-time surroundings data via the cloud can, for instance, further improve the function by incorporating other data, such as weather data or data relating to traffic density.

Real-time surroundings data from in-vehicle surroundings sensors such as cameras, radar, LiDAR, etc. for example, can be used.

FIG. 4 shows a road 401. The reference sign 403 indicates a junction 403. An incoming road 404 joins the road 401 at the junction 403.

The reference sign 405 indicates a location on the road 401 where there is a second lane in the same direction, i.e. an additional lane. This second lane or additional lane is labeled with the reference sign 407.

Numbers 0 to 9 are moreover shown next to the road 401, and these numbers stand for different locations on the road.

FIG. 5 shows a course of a suitability measure along the road 401. Specifically, FIG. 5 shows a graph 501. The locations on the road 401 are shown on the abscissa 503. The abscissa 505 represents the suitability measure. 0, here, indicates that the location is not suitable for overtaking. 1 indicates that the location is suitable for overtaking.

The intent of FIG. 4 is to show an example of how a road layout can be translated into a suitability measure for overtaking. The road initially has a high curvature radius and thus low overtaking feasibility, which corresponds to two factors: visibility and road curvature. This is followed by a short stretch of straight road between 1 and 2, but, because the distance to the next curve is not that long, the overtaking opportunity is not very big. At the exit of the curve at 3, the overtaking opportunity initially increases slightly because a long stretch of straight road is ahead, and as the distance to the next curve decreases, the overtaking opportunity decreases as well. Approaching the curve at 4, the suitability is initially low but, as the visual range increases and the curvature in the direction of 5 decreases, the suitability increases again before rapidly decreasing once more with the approach to the intersection. Approaching 7, the overtaking feasibility, i.e. the suitability measure, increases slightly before decreasing again around the corner and reaches its maximum value on the two-lane road with a lane divider for oncoming traffic.

The suitability measure is described by a continuous function, for example, so that the respective suitability measure can be calculated for each point on a road.

What is claimed is:

1. A method for mapping at least one location on a road suitable for overtaking, comprising the following steps:
ascertaining a plurality of factors of the road relevant to overtaking;
ascertaining a suitability measure for at least one location on the road which indicates a measure of suitability for overtaking at the at least one location based on the ascertained factors relevant to overtaking; and
entering the ascertained suitability measure into a digital road map representing the road.

2. The method according to claim 1, wherein the plurality of factors relevant to overtaking include a lane factor, wherein a number of lanes of the road in each direction of travel at the at least one location is ascertained, wherein the lane factor is ascertained based on the ascertained number of lanes of the road in each direction of travel.

3. The method according to claim 1, wherein the plurality of factors relevant to overtaking include a visual range factor, wherein a visual range, including a horizontal visual range or a vertical visual range, at the at least one location is ascertained, wherein the visual range factor is ascertained based on the ascertained visual range.

4. The method according to claim 1, wherein the plurality of factors relevant to overtaking include a curvature factor, wherein a curvature including a horizontal or a vertical curvature of the road at the at least one location is ascertained, wherein the curvature factor is ascertained based on the ascertained curvature.

5. The method according to claim 1, wherein the plurality of factors relevant to overtaking include a speed limit factor, wherein a maximum permissible speed at the at least one location is ascertained, wherein the speed limit factor is ascertained based on the ascertained maximum permissible speed.

6. The method according to claim 1, wherein the plurality of factors relevant to overtaking include a distance factor, wherein a distance of the road from the at least one location to a next junction of the road is ascertained, wherein the distance factor is ascertained based on the ascertained distance.

7. The method according to claim 1, wherein the plurality of factors relevant to overtaking include a road width factor, wherein a road width at the at least one location is ascertained, wherein the road width factor is ascertained based on the ascertained road width.

8. The method according to claim 1, wherein the plurality of factors relevant to overtaking include a coefficient of sliding friction factor, wherein a coefficient of sliding friction of a lane of the road (401) at the one location is ascertained, wherein the coefficient of sliding friction is ascertained based on the ascertained coefficient of sliding friction.

9. The method according to claim 1, wherein the plurality of factors relevant to overtaking include a road traffic hazard factor, wherein a distance of the road from the at least one location to a road traffic hazard location of a road traffic hazard affecting the road is ascertained, wherein the road traffic hazard factor is ascertained based on the ascertained distance.

10. The method according to claim 1, wherein the plurality of factors relevant to overtaking include a traffic rules relating to overtaking factor, wherein traffic rules relating to overtaking that apply at the at least one location are ascertained, wherein the traffic rules relating to overtaking factor is ascertained based on the traffic rules relating to overtaking that apply.

11. The method according to claim 1, wherein the factors relevant to overtaking are scaled to a predetermined scaling interval to ascertain scaled factors relevant to overtaking, wherein the suitability measure for the at least one location is ascertained based on the scaled factors relevant to overtaking.

12. The method according to claim 1, wherein the factors relevant to overtaking are at least partly weighted with an individual weighting factor to ascertain appropriately weighted factors relevant to overtaking, wherein the suitability measure for the at least one location is ascertained based on the weighted factors relevant to overtaking.

13. The method according to claim 1, wherein a respective suitability measure is ascertained for a plurality of locations on the road that are entered into the digital road map, wherein a compensation calculation is carried out based on the respectively ascertained suitability measures to ascertain a continuous function that best approximates the suitability measures respectively ascertained for the plurality of locations, wherein the ascertained function is entered into the digital road map.

14. The method according to claim 1, wherein real-time surroundings data describing current surroundings at the at least one location are received, wherein the suitability measure is ascertained based on the real-time surroundings data.

15. A device configured to map at least one location on a road suitable for overtaking, the device configured to:
ascertain a plurality of factors of the road relevant to overtaking;
ascertain a suitability measure for at least one location on the road which indicates a measure of suitability for overtaking at the at least one location based on the ascertained factors relevant to overtaking; and
enter the ascertained suitability measure into a digital road map representing the road.

16. A non-transitory machine-readable storage medium on which is stored a computer program including instructions for mapping at least one location on a road suitable for overtaking, the instructions, when executed by a computer, causing the computer to perform the following steps:
ascertaining a plurality of factors of the road relevant to overtaking;
ascertaining a suitability measure for at least one location on the road which indicates a measure of suitability for overtaking at the at least one location based on the ascertained factors relevant to overtaking; and
entering the ascertained suitability measure into a digital road map representing the road.
